(19) United States
(12) Patent Application Publication
(10) Pub. No.: US 2011/0274949 A1
(43) Pub. Date: Nov. 10, 2011

(54) GALVANIC CELL COMPRISING SHEATHING

(75) Inventors: Jens Meintschel, Bernsdorf (DE); Claus-Rupert Hohenthanner, Hanau (DE)

(73) Assignee: LI-TEC, Kamenz (DE)

(21) Appl. No.: 13/145,198

(22) PCT Filed: Jan. 18, 2010
(86) PCT No.: PCT/EP10/00256

§ 371 Date: Jul. 19, 2011

(30) Foreign Application Priority Data
Jan. 21, 2009 (DE) 10 2009 005 498.7
Oct. 12, 2009 (EP) 09 012 869.5

(51) Int. Cl. H01M 10/50; H01M 6/00; H01M 10/44; H01M 2/02; H01M 2/06

(52) U.S. Cl. 429/50; 429/179; 429/164; 429/120; 29/623.1

(57) ABSTRACT

The invention relates to a galvanic cell according to the invention with a substantially prismatic or cylindrical structure and an electrode stack. In addition the galvanic cell has at least one current conductor that is connected to the electrode stack and sheathing that at least partially surrounds the electrode stack. Part of a current conductor extends from said sheathing. The sheathing has at least one first deep drawn part and one second deep drawn part. One deep drawn part has a higher thermal conductivity than the other deep drawn parts. The deep drawn parts of the sheathing are provided to at least partially surround the electrode stack.

Priority application DE 10 2009 005 498.7 is fully incorporated by reference into the present application.

The present invention relates to a galvanic cell for a battery. The invention is described in connection with lithium-ion batteries for supplying motor vehicle drives. It is pointed out that the invention can also find use independently of the chemistry, the design of the galvanic cell or independently of the nature of the supplied drive.

Batteries with a plurality of galvanic cells for supplying motor vehicle drives are known from the prior art. During the operation of such a battery, irreversible chemical reactions also occur in the galvanic cells. These irreversible reactions lead to a reduced charging capacity of the galvanic cells.

The problem underlying the invention is to obtain the charging capacity of the galvanic cells of a battery over a greater number of charging cycles. According to the invention, this is achieved by the subject-matters of the independent claims. Preferred developments of the invention are the subject-matter of the sub-claims.

A galvanic cell according to the invention with, in particular, a substantially prismatic or cylindrical shape comprises an electrode stack. In addition, the galvanic cell comprises at least one current conductor which is connected to the electrode stack. In addition, the galvanic cell comprises a sheathing that at least partially surrounds the electrode stack.

The at least one current conductor extends partially out of the sheathing. The sheathing comprises at least one first shaped part and one second shaped part. One shaped part has a higher thermal conductivity than the other shaped parts. The shaped parts are provided to at least partially surround the electrode stack.

In the present case, a galvanic cell is understood to mean a device which is also used for the delivery of electrical energy. The galvanic cell stores the energy in chemical form. Before delivery of an electric current, the chemical energy is converted into electrical energy. The galvanic cell is potentially also suitable for absorbing electrical energy, converting it into chemical energy and storing it. One then speaks of a rechargeable galvanic cell. The conversion of electrical into chemical energy or vice versa is bound up with losses and is accompanied by irreversible chemical reactions. The effect of the irreversible chemical reactions is that regions of the galvanic cell are no longer available for energy storage and energy conversion. The storage capacity or charging capacity of the galvanic cell thus diminishes with an increasing number of discharging and charging processes or charging cycles. The irreversible chemical reactions also increase with an increasing operating temperature of a galvanic cell. The shape of a galvanic cell can be selected depending on the available space at the place of use. The galvanic cell is preferably substantially cylindrical or prismatic.

In the present case, an electrode stack is understood to mean the arrangement of at least two electrodes and an electrolyte arranged between the latter. The electrolyte can be taken up in part by a separator. The separator then separates the electrodes. The electrode stack is also used for the storage of chemical energy and for its conversion into electrical energy. In the case of a rechargeable galvanic cell, the electrode stack is also capable of converting electrical energy into chemical energy. For example, the electrodes are constituted plate-shaped or film-like. The electrode stack can be coiled round and can have a substantially cylindrical shape. It is then more usual to speak of an electrode coil. In the following, the term electrode stack is also used for electrode coil. The electrode stack can comprise lithium or another alkali metal also in ionic form.

In the present case, a current conductor is understood to mean a device which also enables the flow of electrons from an electrode in the direction of an electrical consumer. The current conductor also acts in the opposite current direction. A current conductor is connected electrically to an electrode or an active electrode earth of the electrode stack and also to a power lead. The shape of a current conductor is adapted to the shape of the galvanic cell or the electrode stack. A current conductor is preferably constituted plate-shaped or film-like. Each electrode of the electrode stack preferably comprises its own current conductor or electrodes of like polarity are connected to a common current conductor.

In the present case, the sheathing is understood to mean a device which also hinders the exit of chemicals from the electrode stack into the surroundings. Furthermore, the sheathing can protect the chemical components of the electrode stack against undesired interaction with the surroundings. For example, the sheathing protects the electrode stack against the admission of water or water vapour from the surroundings. The sheathing can be constituted film-like. The sheathing should impair the passage of thermal energy as little as possible. In the present case, the sheathing comprises at least two shaped parts. The shaped parts preferably fit snugly at least partially with an electrode stack.

In the present case, a shaped part is understood to mean a solid body which is adapted to the shape of the electrode stack. Depending on the circumstances, a shaped part does not acquire its shape until the interaction with another shaped part or the electrode stack. In the case of a parallelepiped-shaped electrode stack, the shaped parts can be cut to shape so as to be substantially rectangular. Some dimensions of the shaped part are preferably selected larger than certain dimensions of the electrode stack. When two shaped parts are placed around the electrode stack, the shaped parts project partially beyond the electrode stack and partially form a projecting edge. An edge region of one shaped part preferably makes contact with an edge region of another shaped part, preferably in a two-dimensionally extending manner. One shaped part is constituted, for example, as a flat plate, whereas another shaped part fits snugly with the first shaped part around the electrode stack.

One shaped part for an electrode coil is constituted preferably cylindrical, the curvature of at least one shaped partshaped part of a cylindrical sheathing being adapted to the radius of an electrode coil.

One shaped partshaped part has a higher thermal conductivity than the other shaped partshaped parts and partially makes contact with the electrode stack in a heat-conducting manner. Depending on the temperature difference between the shaped partshaped part and the electrode stack, thermal energy is transferred from the electrode stack or into this electrode stack.

In the present case, surround is understood to mean that one shaped partshaped part can be brought into contact in sections with a second shaped partshaped part. The electrode stack thereby lies between the shaped partshaped parts concerned. The at least two shaped partshaped parts make two-dimensionally extending contact with one another in sections, preferably at least along a limiting edge or an edge region of a shaped partshaped part concerned.

In order to supply a motor vehicle drive, high electric currents are withdrawn from time to time from the battery and can lead to marked heating of the galvanic cells of a battery. With increasing temperature, irreversible chemical reactions also increase in a galvanic cell. According to the invention, the sheathing of the galvanic cell is constituted by a shaped partshaped part which is characterised by a distinctly higher thermal conductivity than the other parts of the sheathing. The thermal resistance can thus be reduced and the heat flow into the electrode stack or out of the electrode stack can be increased. A heat output in a galvanic cell with a smaller temperature difference can thus be carried away.

With the limitation of the operating temperature of a galvanic cell, irreversible chemical reactions are reduced, the charging capacities of the galvanic cells are retained over a large number of charging cycles and the underlying problem is solved.

Preferred embodiments of the invention are described below.

To advantage, at least two shaped partshaped parts of the sheathing are provided, to be connected to one another. The connection takes place, for example, in a friction-locked or preferably firmly bonded manner. Depending on the materials of the different shaped partshaped parts, the latter are connected to one another, for example, by gluing or a welding process. In particular, ultrasonic welding can be used to connect a metal shaped partshaped part with a thermoplastic shaped partshaped part. A preliminary treatment or activation of at least one of the surfaces of an involved shaped partshaped part may be useful here. A friction-locked or firmly bonded connection connects the shaped partshaped parts in such a way that a peripheral strip-shaped connection preferably seals the space between the shaped partshaped parts with respect to the surroundings. In order to improve the adhesion, inserted strips can also be used, for example a sealing strips. At least two shaped partshaped parts are preferably connected to one another, particularly in a firmly bonded manner, in a first connection region. This first connection region preferably runs along an edge region of an involved shaped partshaped part. The first connection region is constituted strip-shaped. It is not necessary for the first connection region to run around completely along the limiting edges of the shaped partshaped part. Before the connection of the shaped partshaped parts concerned, other insertions parts can be disposed in such a way that the latter are also connected with the shaped partshaped parts in a friction-locked or firmly bonded manner. In particular, the current conductors are inserted in such a way that the latter extend partially out of the sheathing. In the regions of the current conductors, the sheathing is thus also gas-tight with respect to the surroundings.

To advantage, at least one shaped partshaped part of the sheathing comprises a heat transfer region. This heat transfer region also serves to improve the heat transmission into the electrode stack or out of the latter. A first temperature-regulating medium preferably flows against the heat transfer region and/or the heat transfer region is in heat-conducting contact with a temperature-regulating element. A heat transfer region of a shaped partshaped part can also cover a predominant part of the surface of the shaped partshaped part. The heat transfer region can at the same time also be used to fix the galvanic cell to a temperature-regulating element, for example by screws, rivets, gluing or welding.

At least one shaped partshaped part of the sheathing is preferably constituted flexurally stiff. This shaped partshaped part can provide support for the electrode stack, protect the electrode stack against mechanical damage or be used for the mechanical connection of the galvanic cell with a receiving device. A flexurally stiff shaped partshaped part is preferably constituted as a metal plate or a sheet metal. The shaped partshaped part can be stiffened for example by crimping, upturned edge regions or ribs.

At least one shaped partshaped part of the sheathing is preferably constituted thin-walled. The wall thickness of a shaped partshaped part is preferably adapted to mechanical, electrical or thermal stressing. The wall thickness does not have to be uniform. A region of a thin-wall shaped partshaped part with a greater wall thickness can act as a heat sink or heat reservoir and thus contribute towards thermal energy being carried away from the electrode stack or transported into the latter. The thin-wall design of a shaped partshaped part also saves on weight and space. At least one shaped partshaped part is preferably constituted as a film, particularly preferably as a composite film. Metals or plastics can also be considered as materials for the composite film.

At least one shaped partshaped part of the sheathing preferably comprises a coating at least in sections. This coating is also used for adaptation to stresses to which the shaped partshaped part is subjected. For example, the coating is used for electrical insulation, for protecting the shaped partshaped part against the chemicals of the galvanic cell, for improving adhesion for an adhesive joint, for improving the thermal conductivity or for protection against damaging effects from the surroundings. A coating can produce a chemical activation of the surface of the shaped partshaped part. A coating is preferably made from a material which differs from the material of the shaped partshaped part. The at least one shaped partshaped part can also comprise a plurality of different coatings, which can also be disposed at different places on the shaped partshaped part. If a shaped partshaped part is in electrical contact with the electrode stack, a current conductor is preferably electrically insulated with respect to this shaped partshaped part.

To advantage, at least one shaped partshaped part of the sheathing comprises a cutout, in particular a shell. With this embodiment, the shaped partshaped part also acquires an increased planar moment of inertia or flexural strength. This cutout preferably at least partially accommodates the electrode stack. This also serves to protect the electrode stack. The wall thickness of a shaped partshaped part with a cutout is preferably adapted to the stress. A plurality of shaped partshaped parts of the sheathing can comprise cutouts, which jointly form a space for accommodating the electrode stack. One shaped partshaped part is preferably constituted as a deep-drawn or cold-extruded sheet metal. One shaped partshaped part is preferably constituted as a deep-drawn plastic sheet or a plastic film. A shaped partshaped part of the sheathing with a cutout additionally comprises at least a first connection region, which is provided for the connection with another shaped partshaped part.

In the case of a cylindrical galvanic cell or an electrode coil, at least one shaped partshaped part is preferably constituted shell-shaped. The curvature of the shell-shaped shaped partshaped part is adapted to the radius of the electrode coil.

To advantage, at least one shaped partshaped part comprises a second connection region. The second connection region is also used for fixing the galvanic cell, for example in a housing, in a frame or on a base plate. A second connection region is preferably constituted such that the connection of the shaped partshaped part concerned with another body takes place only in a predetermined manner.

For example, a second connection region has a geometrical shape which corresponds to a region of another body.

A connection between the shaped partshaped part and the other body only in a predetermined manner can preferably be achieved by means of an arrangement of shaped elements, for example holes and pegs. The arrangement of through-holes or threads can also permit a connection only in a predetermined manner. A second connection region is preferably spatially separated from a first connection region. At least one shaped partshaped part of the sheathing preferably comprises a plurality of separated second connection regions. The connection of the shaped partshaped part with another body takes place, for example, by means of rivets, screws, welding or gluing. A second connection region of a shaped partshaped part and a heat transfer region of said shaped partshaped part preferably coincide. In these regions, the shaped partshaped part is connected, for example, to a temperature-regulating element, a frame or to a base plate of the battery housing.

To advantage, at least two galvanic cells are grouped to form a battery. The at least two galvanic cells are preferably arranged parallel to one another. Prismatic or parallelepiped-shaped cells are preferably brought into contact with one another in a two-dimensionally extending manner and can form a substantially parallelepiped-shaped pack.

Cylindrical cells are preferably disposed in such a way that their longitudinal or symmetrical axes run parallel or coincide. The sheathing for the electrode coil is preferably constituted cylindrical, the curvature of at least one shaped partshaped part of a cylindrical sheathing being adapted to the radius of an electrode coil.

At least one temperature-regulating element is also assigned to the battery. The temperature-regulating element has a predetermined temperature, which may be variable over time. The temperature of the temperature-regulating element is preferably selected depending on the temperature of the electrode stack of a galvanic cell. A predetermined temperature gradient causes a heat flow into this electrode stack or out of this electrode stack. The temperature-regulating element exchanges thermal energy with the electrode stack via at least one shaped partshaped part or its heat transfer region, which is in contact with the temperature-regulating element. The existing galvanic cells can also be connected to the temperature-regulating element, in particular in a friction-locked or firmly bonded manner, via a second connection region.

To advantage, the temperature-regulating element comprises at least a first channel also for the adjustment of a preset temperature of the temperature-regulating element. This channel is preferably filled with a second temperature-regulating medium. A second temperature-regulating medium particularly preferably flows through this at least one channel. The flowing second temperature-regulating medium supplies thermal energy to the temperature-regulating element or removes thermal energy from the latter. The at least one temperature-regulating element is preferably in an active connection with a heat exchanger. The heat exchanger carries away thermal energy from this temperature-regulating element or supplies thermal energy to this temperature-regulating element, in particular by means of the second temperature-regulating medium. The heat exchanger and the temperature-regulating medium can also interact with the air-conditioning system of a motor vehicle. The heat exchanger can comprise an electric heating unit.

To advantage, a battery with at least two galvanic cells is operated in such a way that a first temperature-regulating medium flows against at least one shaped partshaped part of a galvanic cell. For example, ambient air or a coolant of the air-conditioning system of the motor vehicle is used as the first temperature-regulating medium. The first temperature-regulating medium can have a higher or lower temperature than the at least one shaped partshaped part, its heat transfer region, or than an electrode stack.

To advantage, a galvanic cell according to the invention is produced in such a way that at least two shaped partshaped parts of the sheathing are first placed together around an electrode stack. The current conductors of the galvanic cell can thereby be inserted. The two shaped partshaped parts are then connected to one another, especially in a firmly bonded manner, so that an, in particular, peripheral connection of at least two shaped parts is produced. A gas-tight sheathing around the electrode stack is thus preferably produced.

At least one shaped part is then transferred into a deformed state by bending, especially by upturning at least one edge region of the shaped part. The first connection region is preferably at least partially bent. A dimension of the at least one shaped part can thereby be reduced. To advantage, the upturned regions of the shaped part produce an additional mechanical protection of the electrode stack. To advantage, an upturned edge region increases the planar moment of inertia of the shaped part concerned.

Further advantages, features and possible applications of the present invention emerge from the following description in connection with the figures. In the figures:

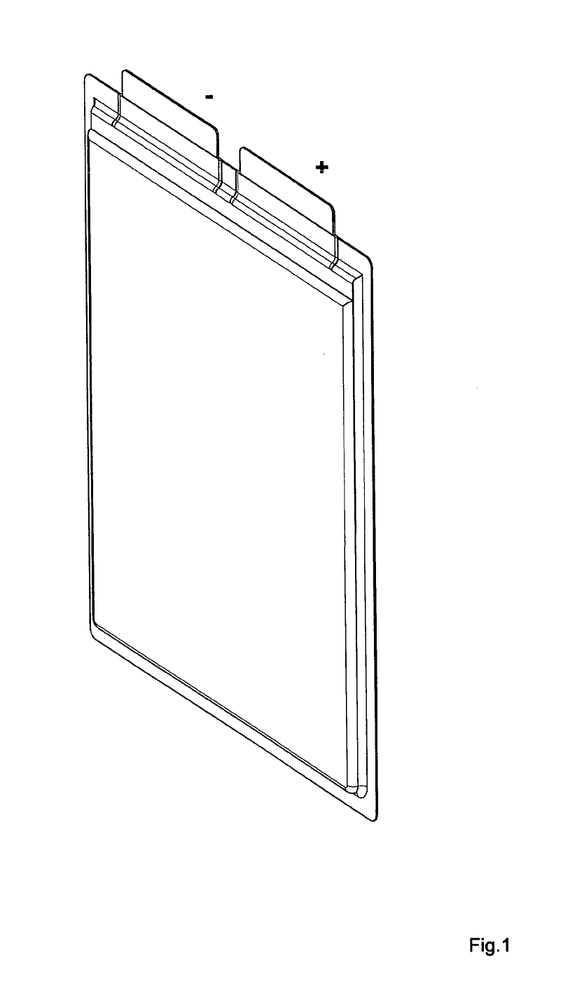

FIG. 1 shows a perspective view of a galvanic cell of the prior art,

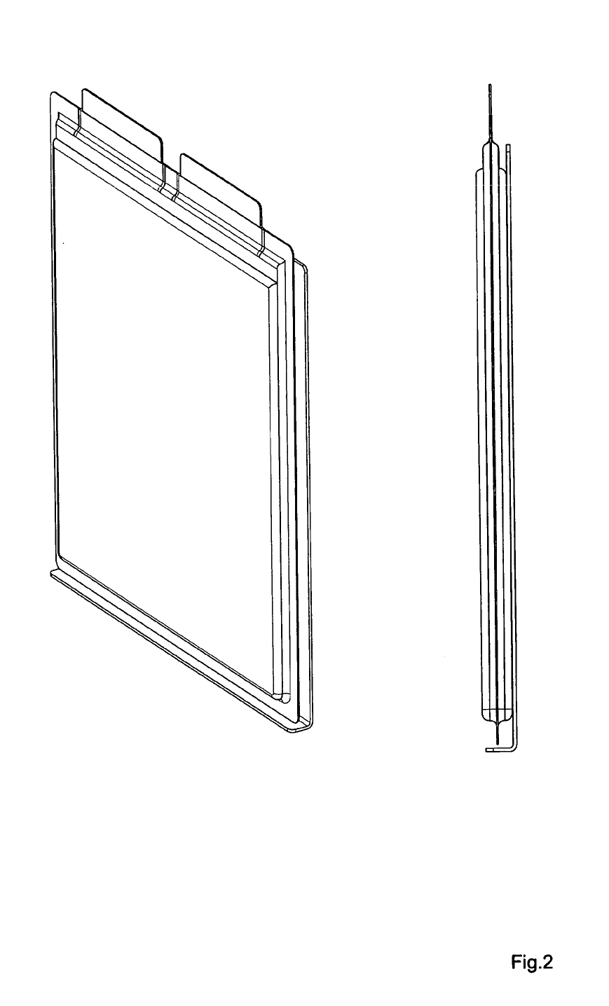

FIG. 2 shows a perspective view and a side view of a galvanic cell of the prior art with a cooling plate,

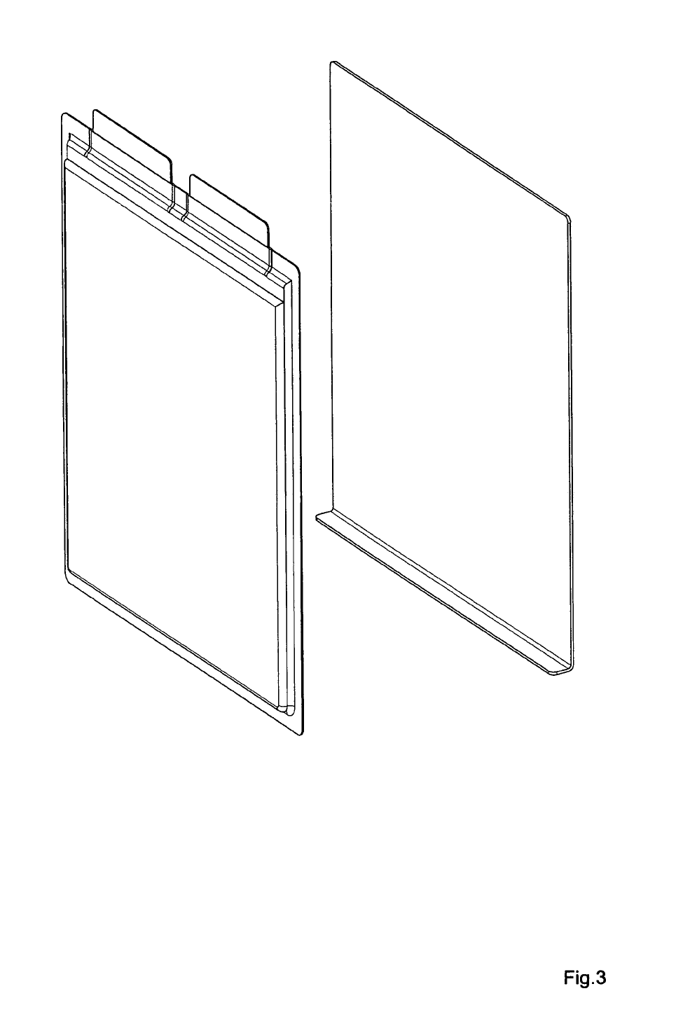

FIG. 3 shows an exploded view of a galvanic cell of the prior art with a cooling plate,

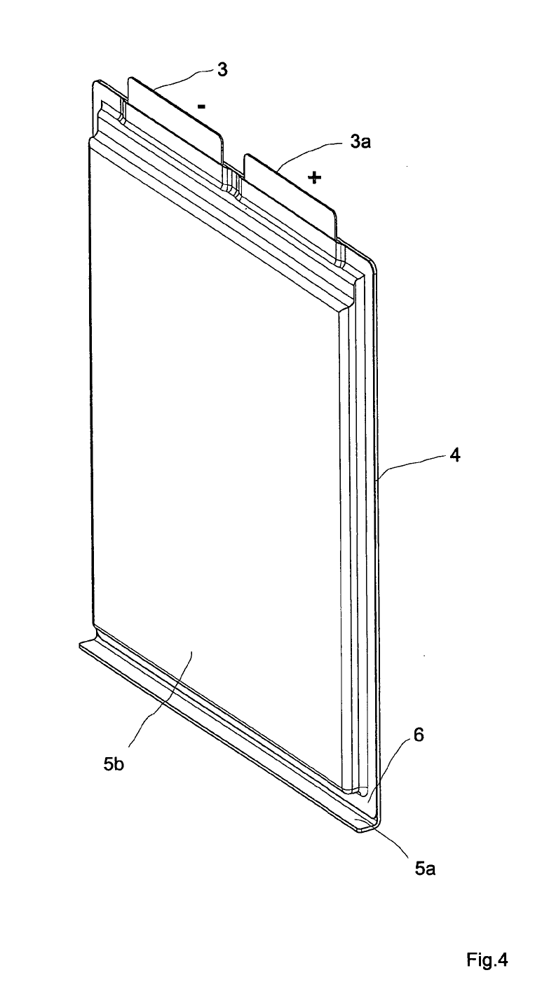

FIG. 4 shows a perspective view of a galvanic cell with a shaped part according to the invention,

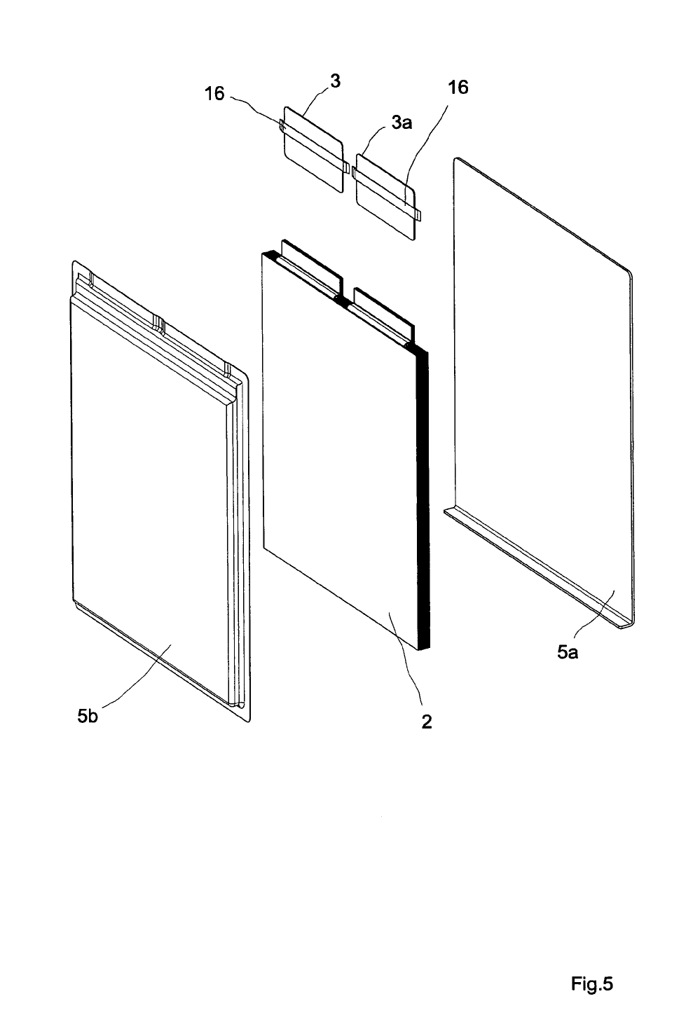

FIG. 5 shows an exploded view of a galvanic cell with a shaped part according to the invention,

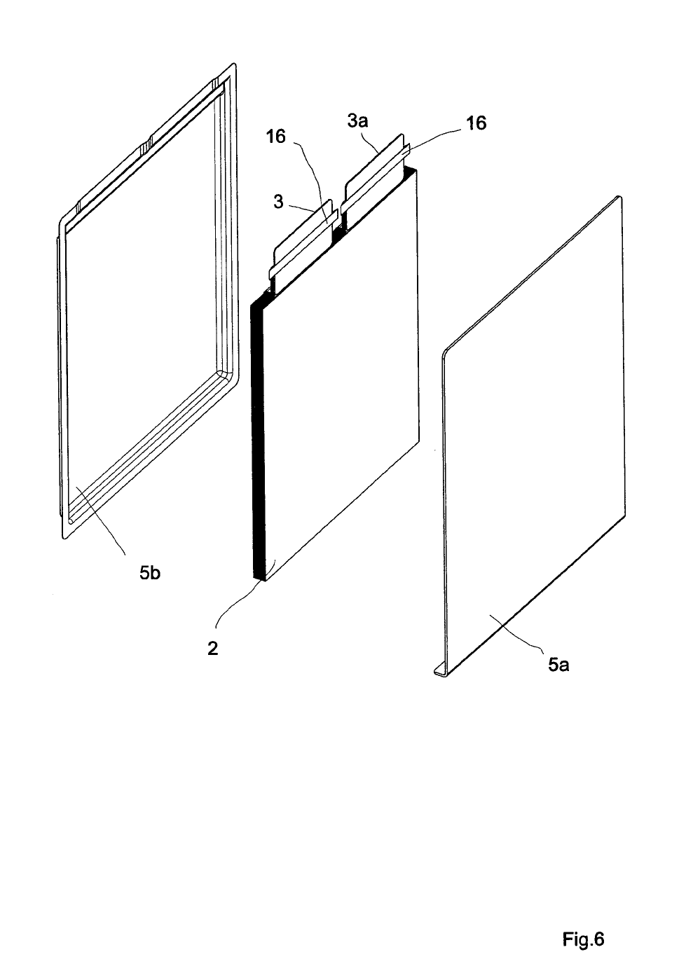

FIG. 6 shows a further exploded view of a galvanic cell with a shaped part according to the invention,

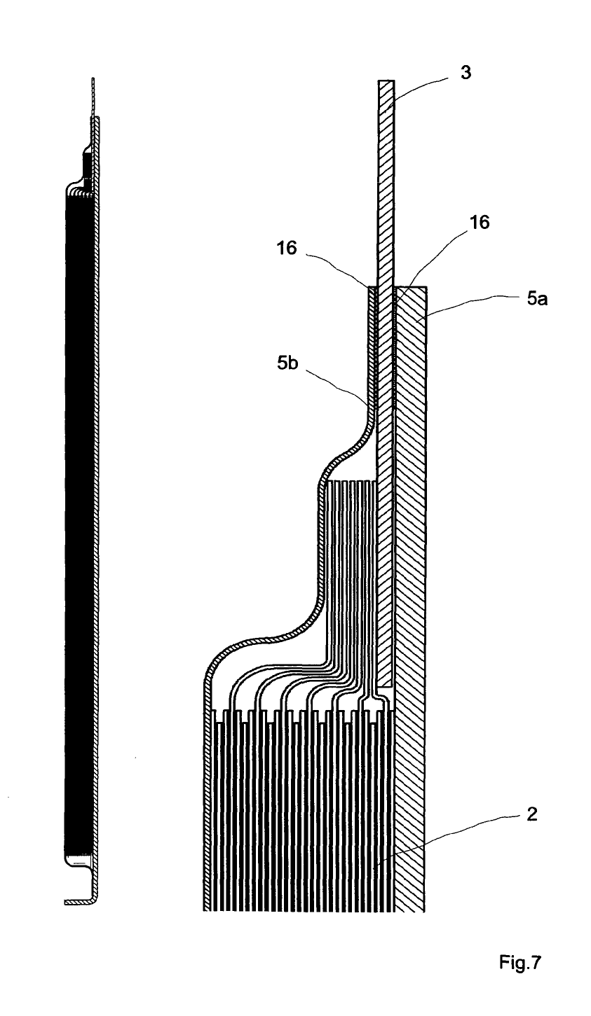

FIG. 7 shows a cross-section and an enlarged detail of a galvanic cell with a shaped part according to the invention,

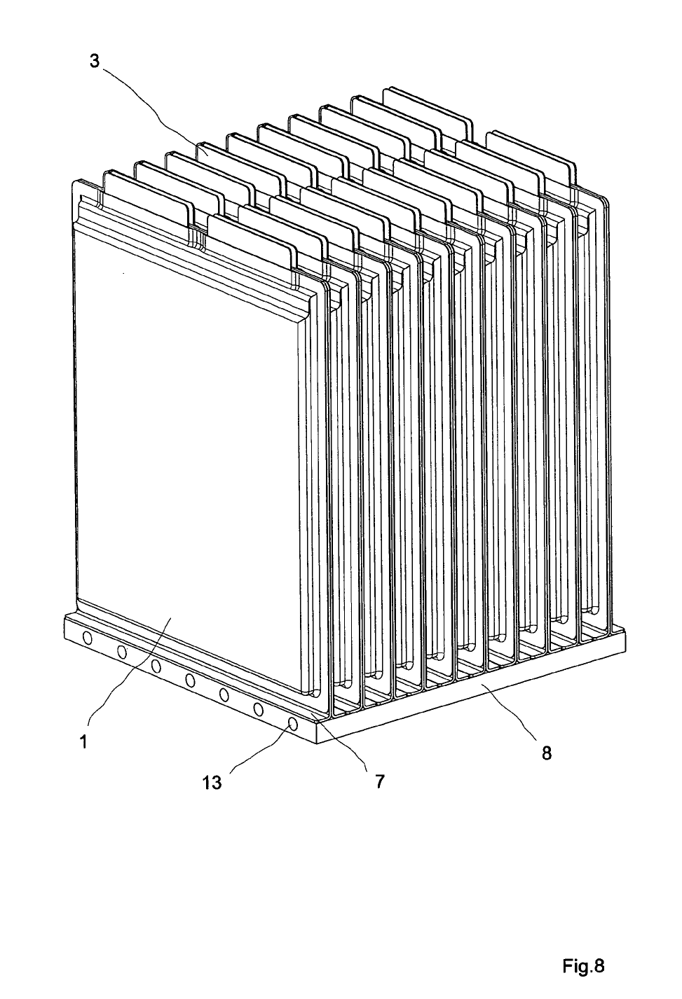

FIG. 8 shows a perspective view of a cell block with galvanic cells with a shaped part according to the invention on a temperature-regulating plate,

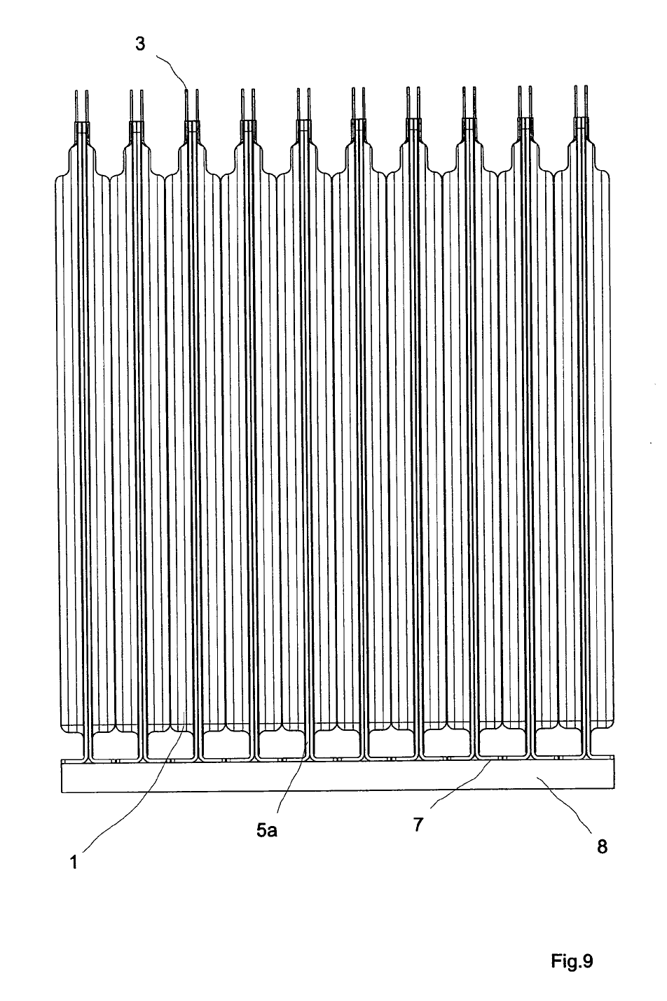

FIG. 9 shows a side view of a cell block with galvanic cells with a shaped part according to the invention on a temperature-regulating plate,

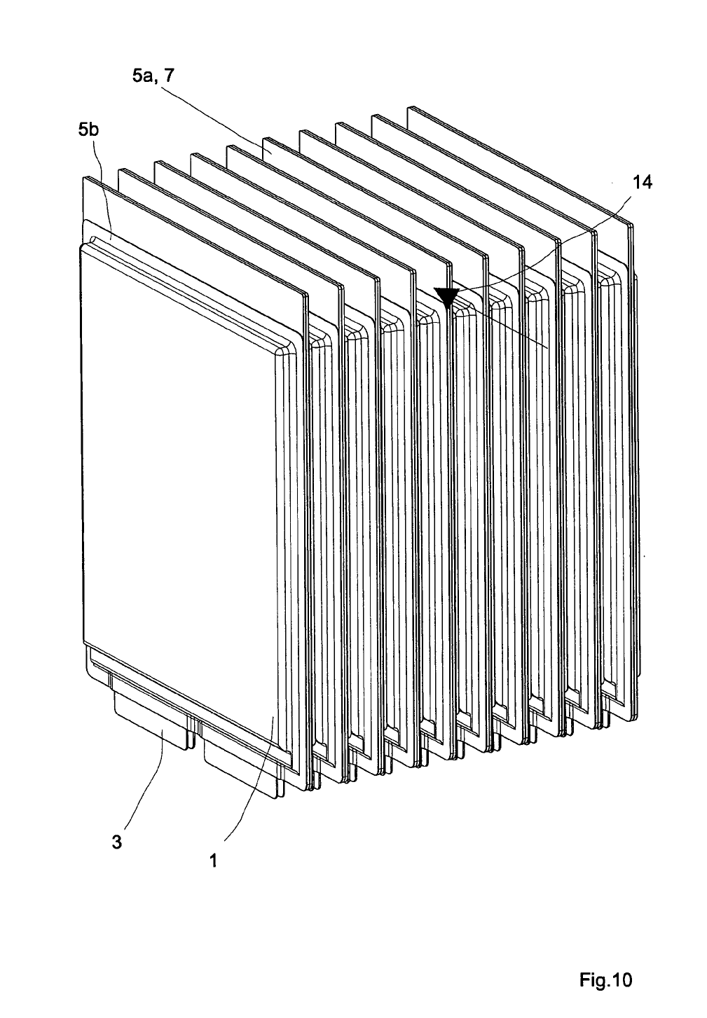

FIG. 10 shows a side view of a cell block with galvanic cells with a shaped part according to the invention in contact with a first temperature-regulating medium,

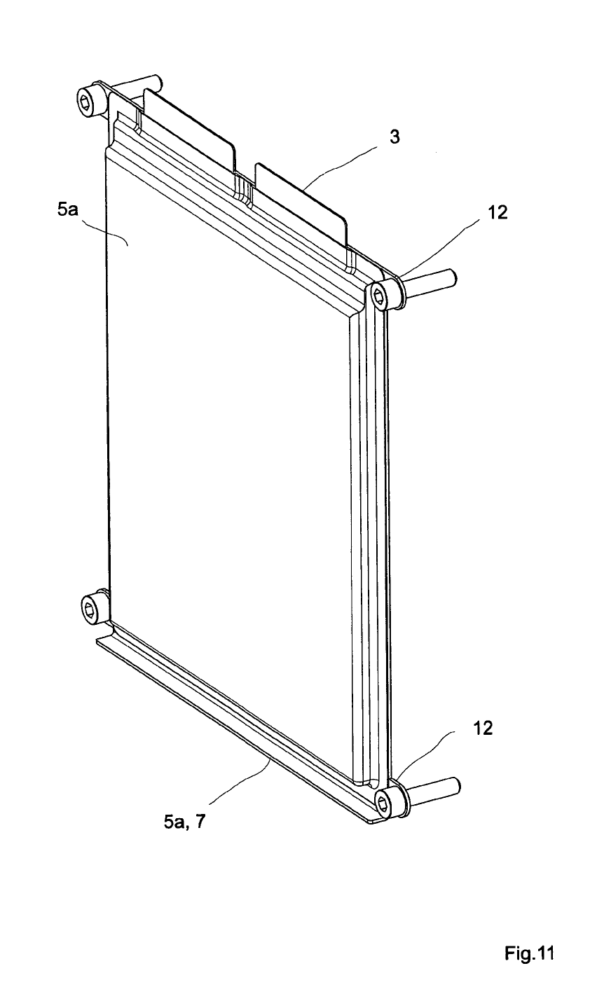

FIG. 11 shows a perspective view of a galvanic cell with a shaped part according to the invention and second connection regions,

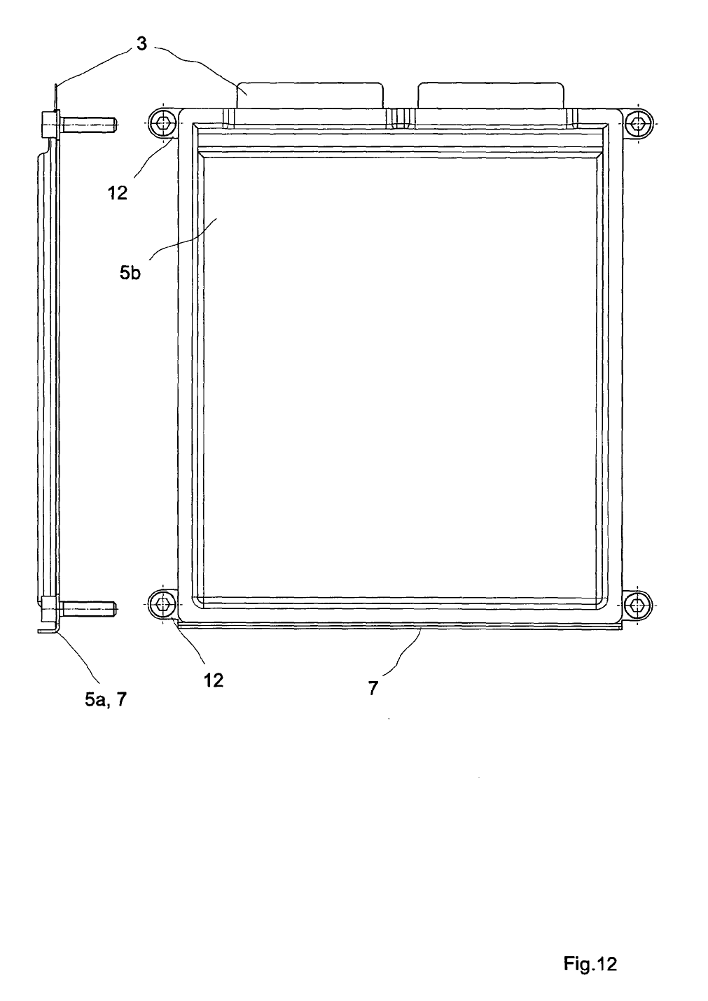

FIG. 12 shows a side view and front view of a galvanic cell according to the invention with a plurality of second connection regions,

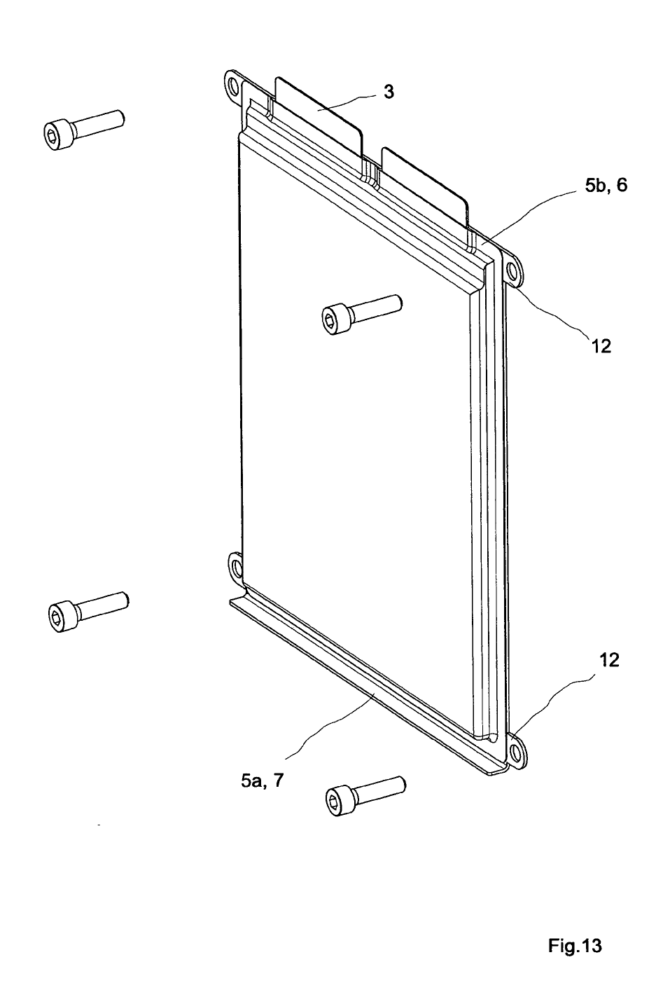

FIG. 13 shows an exploded view of a galvanic cell with a shaped part according to the invention with a plurality of second connection regions,

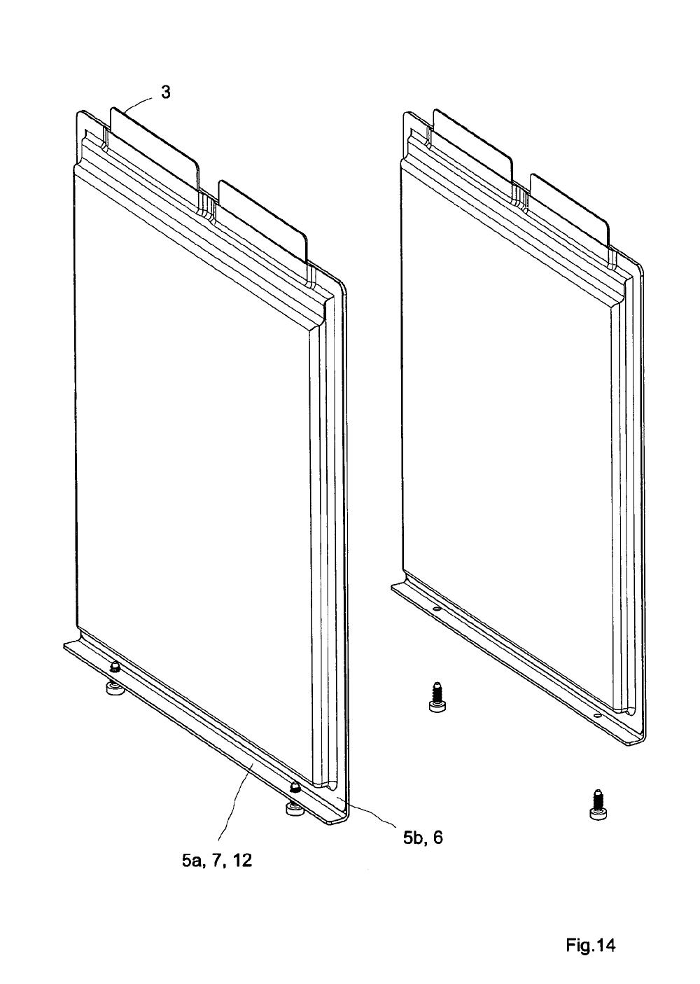

FIG. 14 shows two perspective views of a galvanic cell with a shaped part according to the invention, which can be fixed by means of self-tapping screws to a temperature-regulating element,

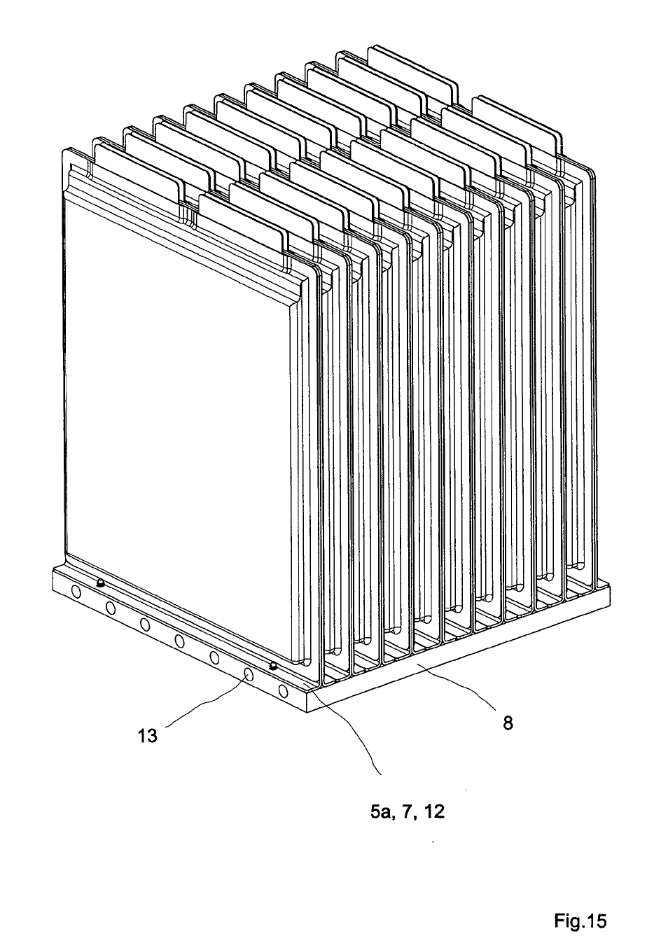

FIG. 15 shows a perspective view of a cell block comprising galvanic cells with a shaped part according to the invention, which are fixed by means of self-tapping screws to a temperature-regulating element,

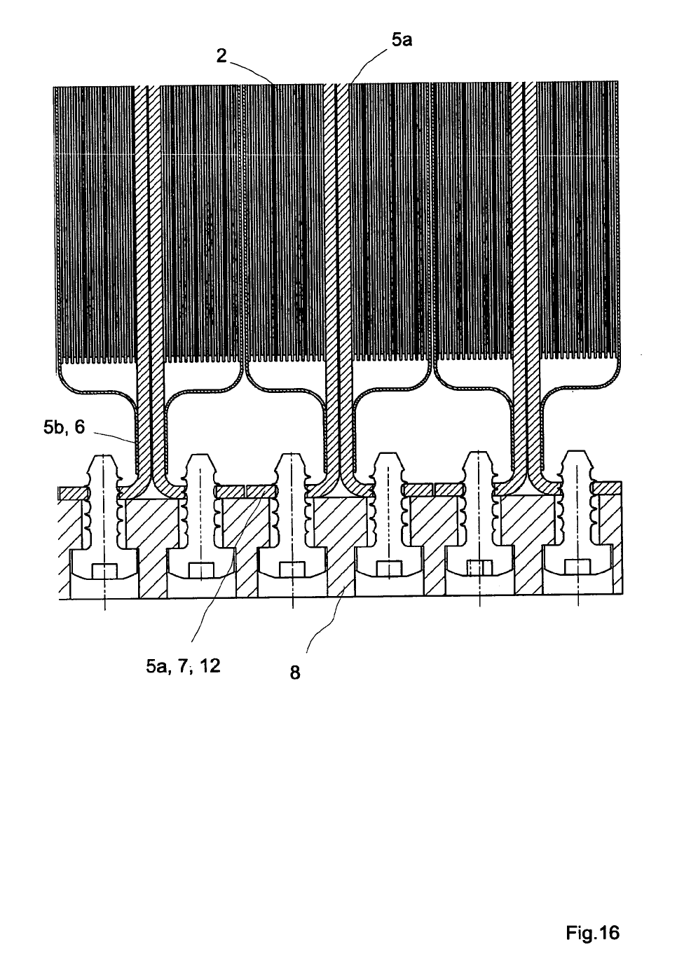

FIG. 16 shows a sectional representation of a cell block comprising galvanic cells with a shaped part according to the invention, which are fixed by means of self-tapping screws to a temperature-regulating element,

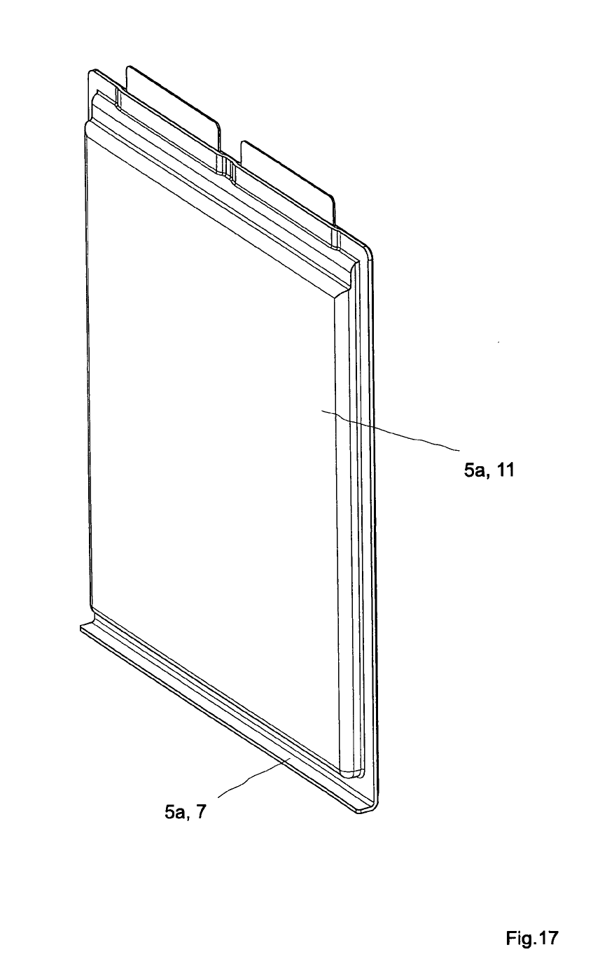

FIG. 17 shows a perspective view of a galvanic cell with a shaped part according to the invention, which is constituted as a shell,

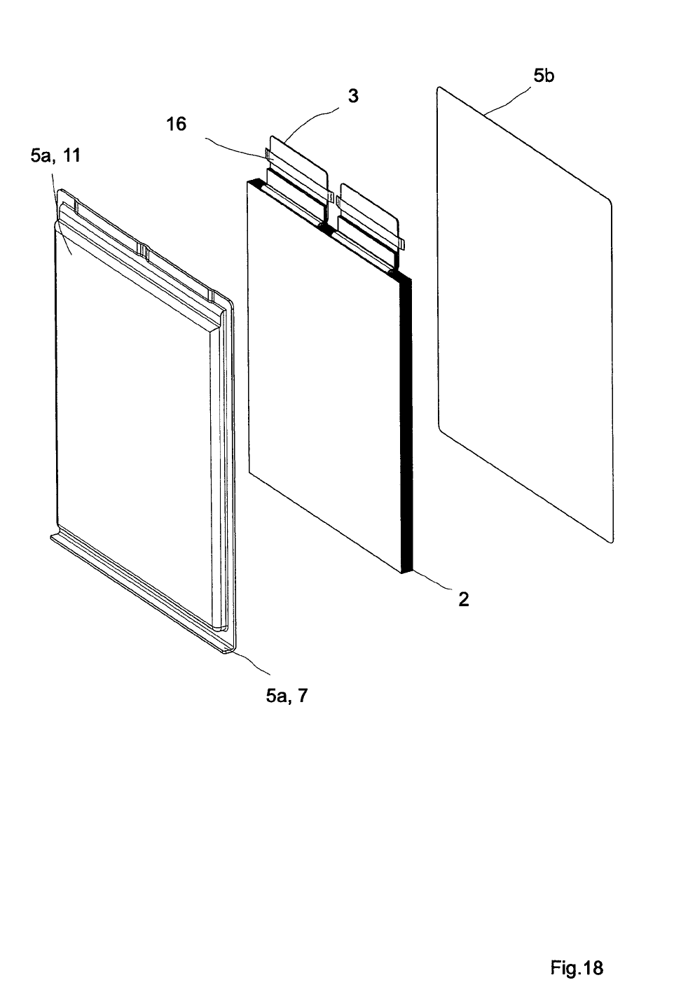

FIG. 18 shows an exploded view of a galvanic cell with a shaped part according to the invention, which is constituted as a shell,

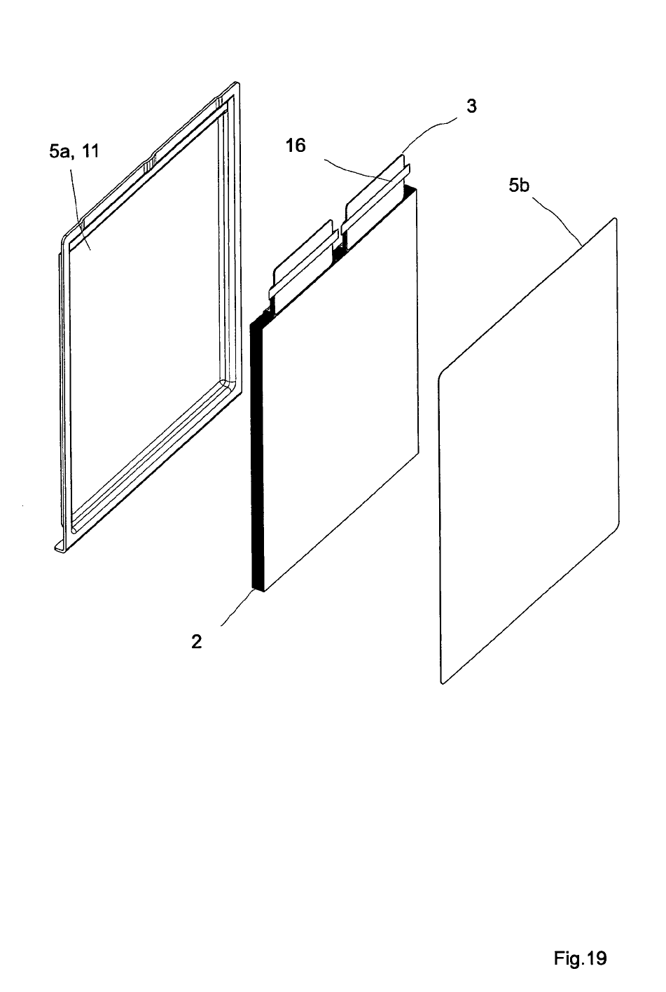

FIG. 19 shows a further exploded view of a galvanic cell with a shaped part according to the invention, which is constituted as a shell,

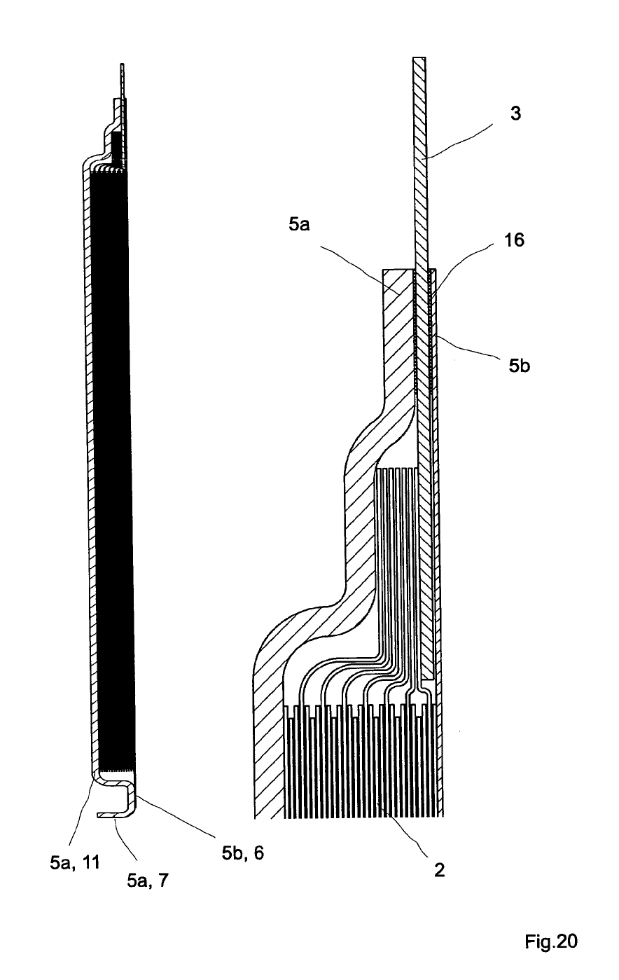

FIG. 20 shows a sectional representation and an enlarged detail of a galvanic cell with a shaped part according to the invention, which is constituted as a shell,

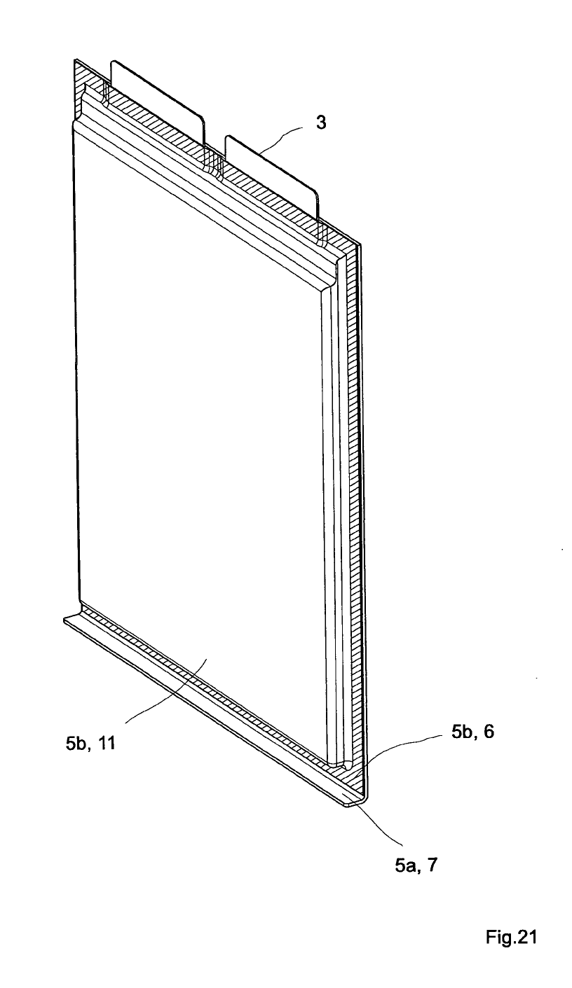

FIG. 21 shows a perspective view of a galvanic cell with a shaped part according to the invention in the initial state,

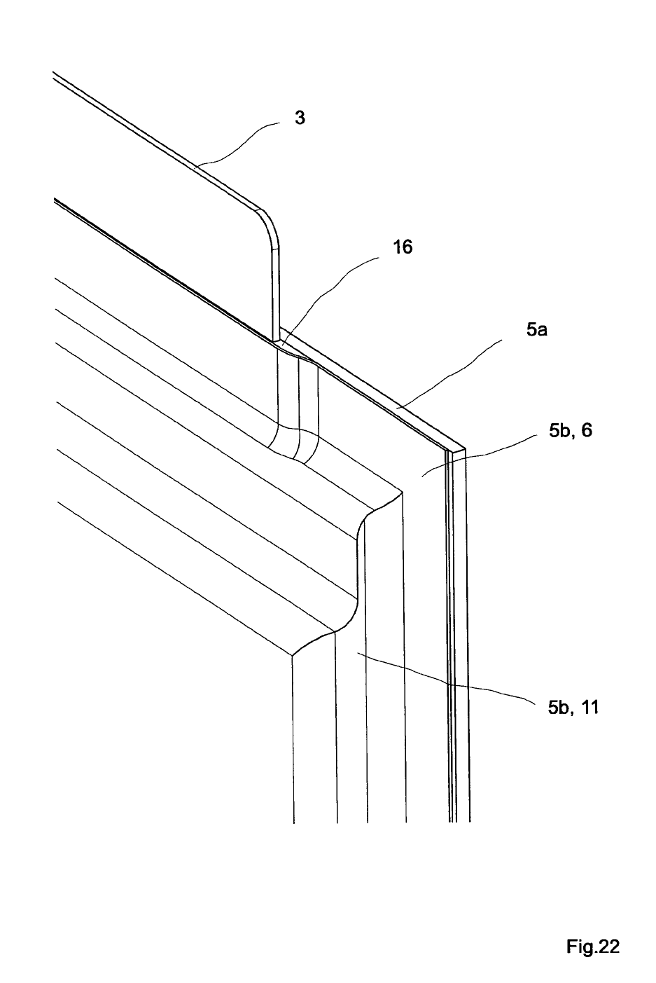

FIG. 22 shows, as an enlarged detail, a perspective view of a galvanic cell with a shaped part according to the invention in the initial state,

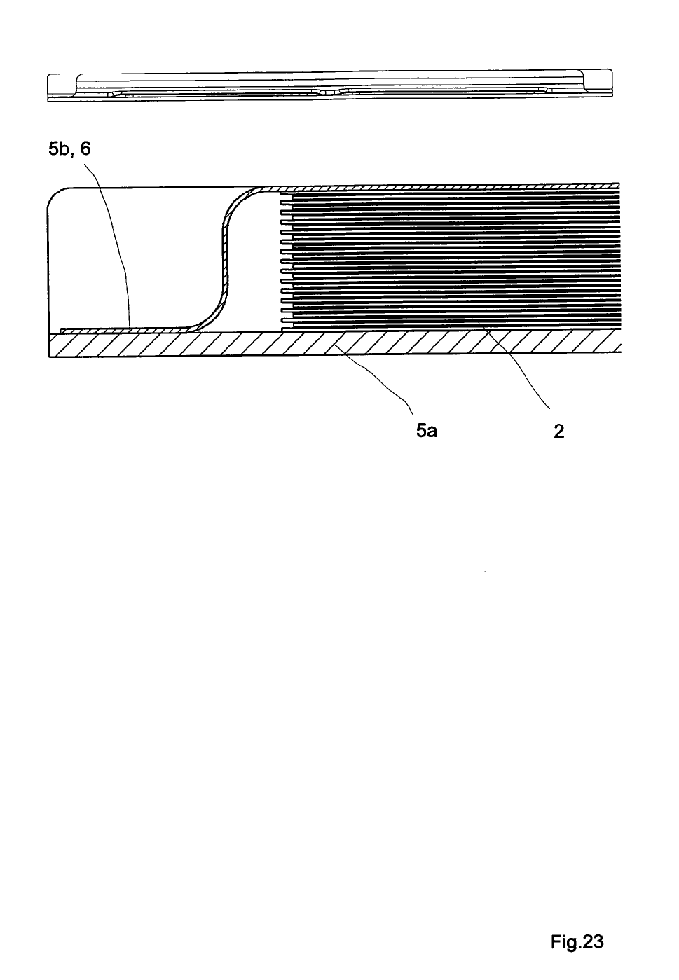

FIG. 23 shows a side view and a cross-section through a galvanic cell with a shaped part according to the invention in the initial state,

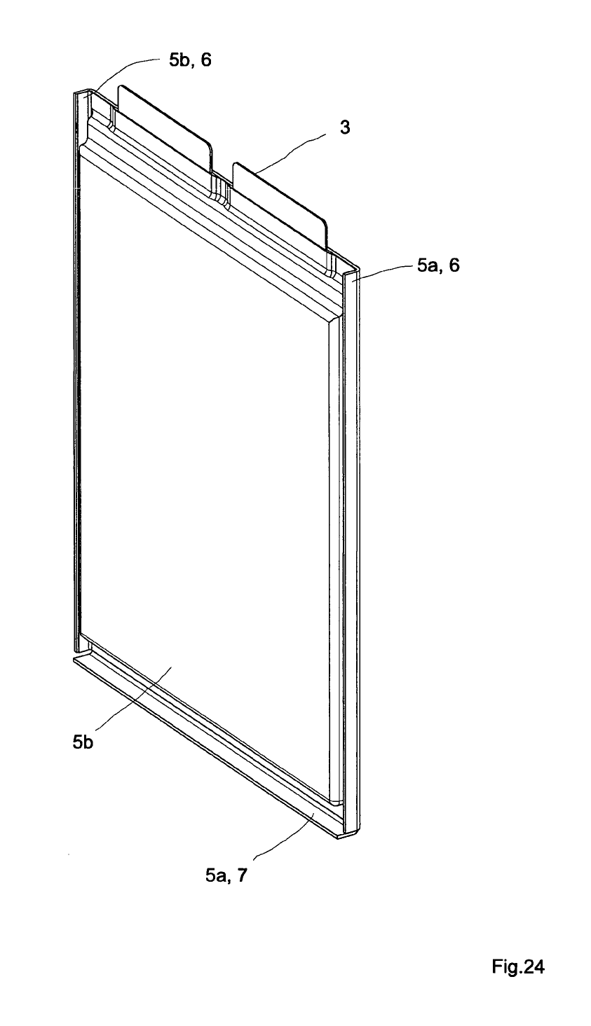

FIG. 24 shows a perspective view of a galvanic cell with a shaped part according to the invention in the deformed state,

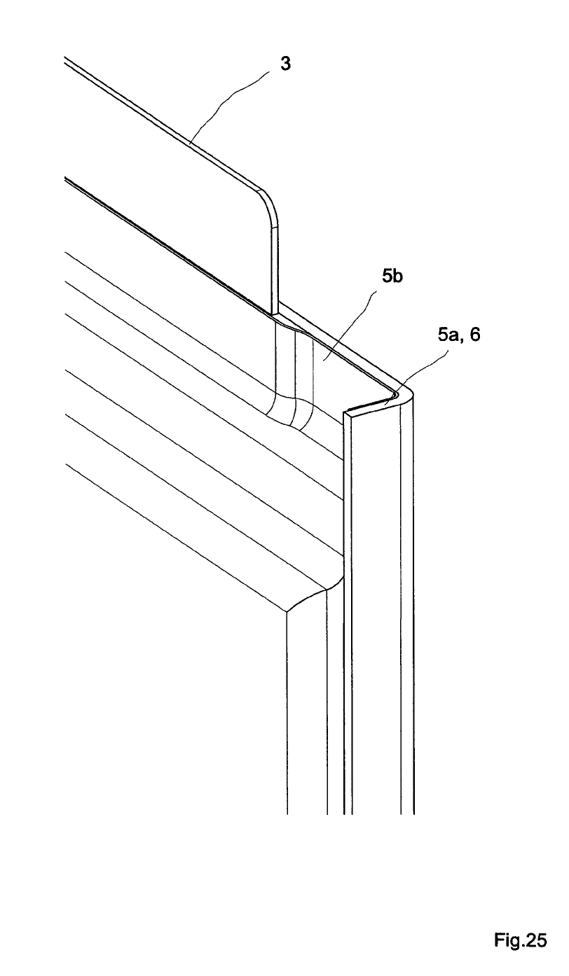

FIG. 25 shows, as an enlarged detail, a perspective view of a galvanic cell with a shaped part according to the invention in the deformed state,

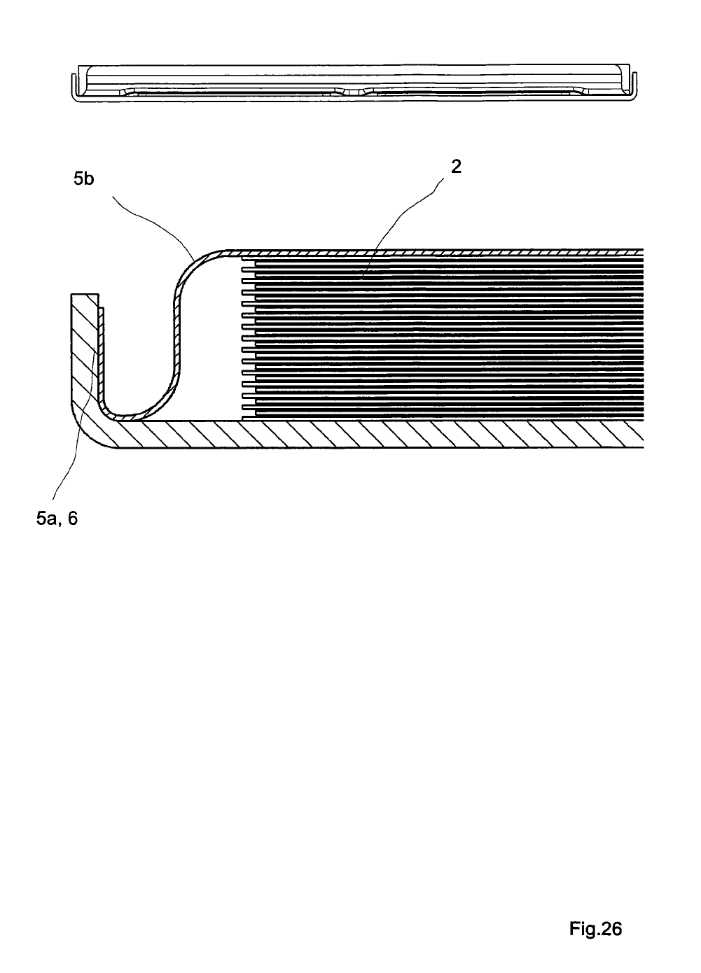

FIG. 26 shows a side view and a cross-section through a galvanic cell with a shaped part according to the invention in the deformed state,

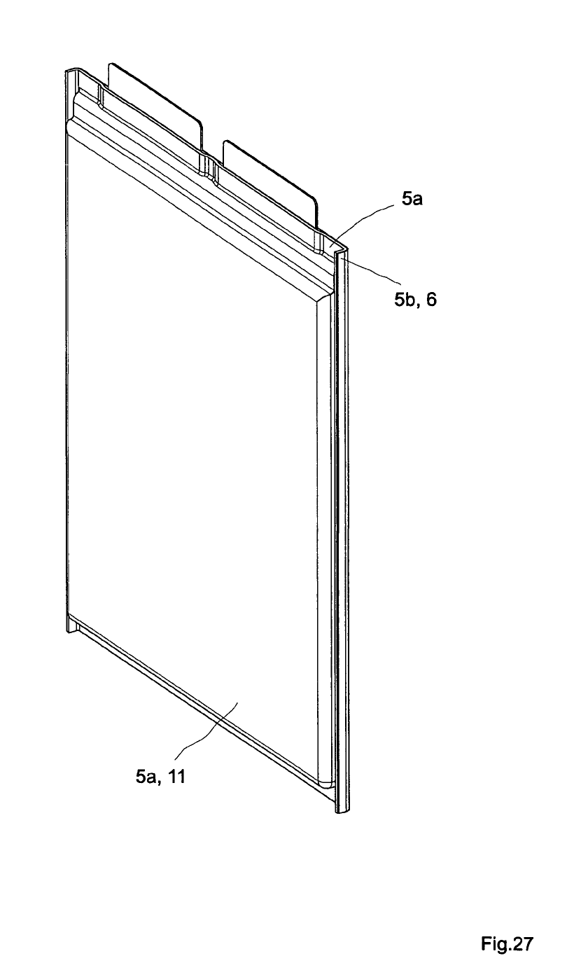

FIG. 27 shows a perspective view of a galvanic cell with a shaped part according to the invention, which is constituted as a shell, in the deformed state,

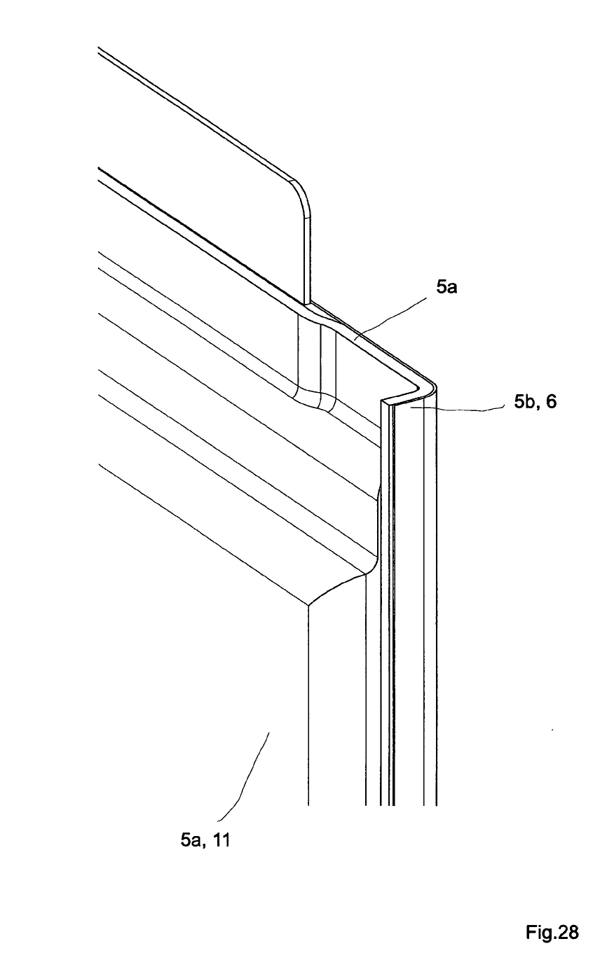

FIG. 28 shows, as an enlarged detail, a perspective view of a galvanic cell with a shaped part according to the invention, which is constituted as a shell, in the deformed state,

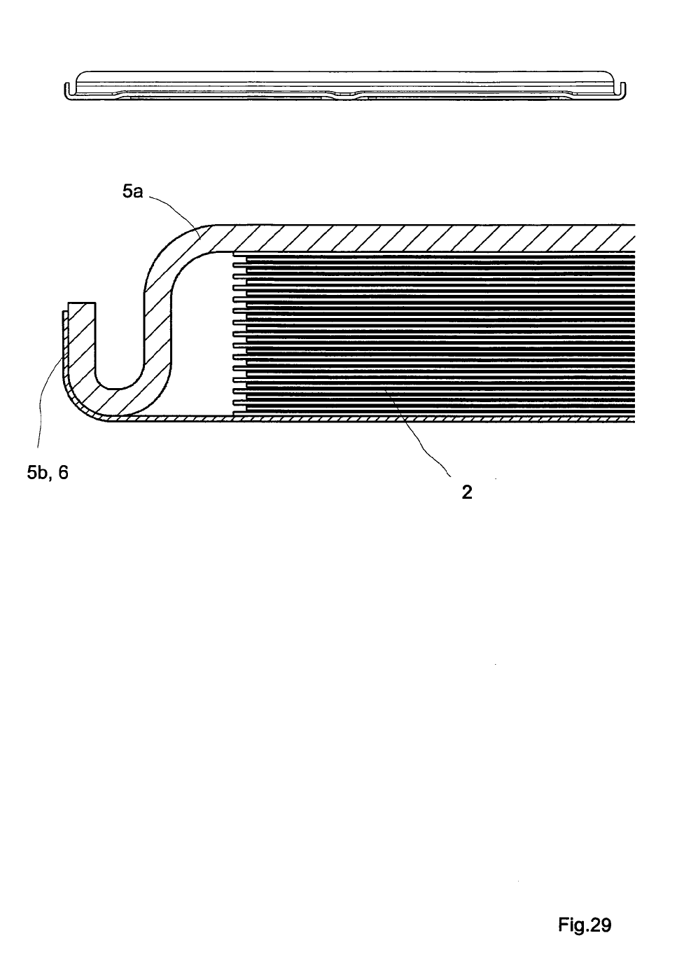

FIG. 29 shows a side view and a cross-section through a galvanic cell with a shaped part according to the invention, which is constituted as a shell, in the deformed state and

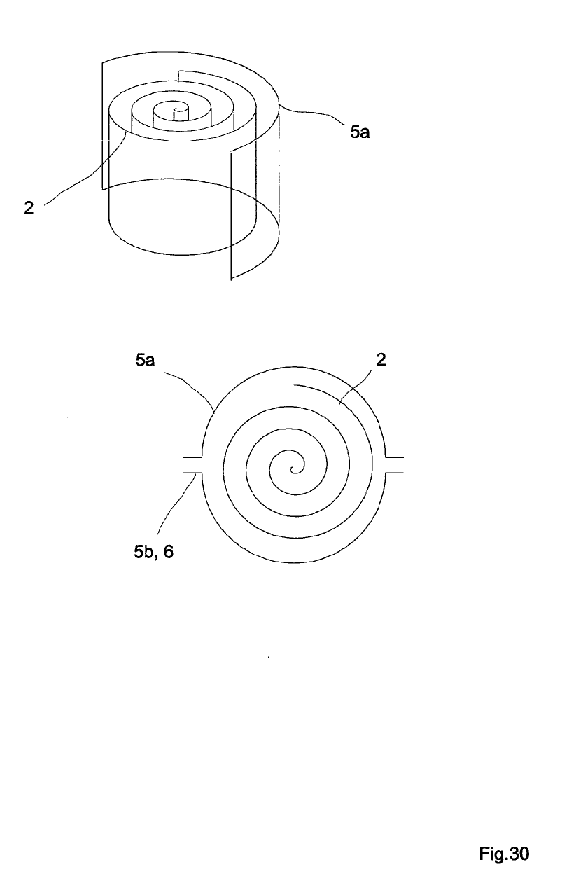

FIG. 30 shows a electrode coil, disposed in shaped parts constituted as a shell.

FIG. 1 shows a galvanic cell from the prior art. The latter comprises an electrode stack, which is completely surrounded by a film-like sheathing. FIGS. 2 and 3 show a galvanic cell according to the prior art, to which a cooling plate is assigned. The cooling plate is in contact with the sheathing of the galvanic cell in a two-dimensionally extending manner. The cooling plate is bent off at the lower end.

FIG. 4 shows a galvanic cell 1. Its sheathing 4 comprises a shaped part 5a according to the invention. The latter is connected in a firmly bonded manner along a peripheral sealing seam with a composite film as a second shaped part 5b. The two current conductors 3, 3a are connected in a firmly bonded manner to shaped parts 5a, 5b. The lower edge of a shaped part 5a is upturned. This upturned edge also acts as a heat transfer region 7. Electrode stack 2 of galvanic cell 1 is enclosed between shaped parts 5a, 5b of sheathing 4 in such a way that electrode stack 2 is for the most part secured against slipping. A shaped part 5a according to the invention also makes a considerable contribution towards the heat exchange with electrode stack 2 and towards its protection.

FIGS. 5 and 6 show essential components of the galvanic cell. Shaped part 5b is constituted as a plastic film. It does not acquire its shape until after the enclosure of the electrode stack jointly with second shaped part 5a. A shaped part 5b can be constituted in a dimensionally stable manner, in particular by means of deep-drawing. The two current conductors 3, 3a are each provided with a sealing strip 16. The latter also improve the sealing of sheathing 4.

FIG. 7 shows a cross-section through a galvanic cell 1 according to the invention. Two shaped parts 5a, 5b, a current conductor 3, 3a and a sealing strip 16 make contact with one another in a sealing manner, in particular a firmly bonded manner. It is also shown that electrode stack 2 comprises numerous electrodes and separators. It is also shown that the electrodes of like polarity are preferably welded by means of terminal tabs to current conductor 3, 3a.

FIGS. 8 and 9 show an arrangement of a plurality of galvanic cells 1 on a common temperature-regulating element 8. Temperature-regulating element 8 is provided with a plurality of first channels 13 for a second temperature-regulating medium 14. A shaped part 5a of each galvanic cell 1 is in each case constituted as a sheet metal. The lower edge of each sheet metal is upturned and forms a heat transfer region 7. This heat transfer region 7 is at least in heat-conducting contact with temperature-regulating element 8. Galvanic cells 1 are disposed in such a way that heat-conducting shaped parts 5a of, in each case, two galvanic cells 1 are in contact with one another.

FIG. 10 shows a large number of galvanic cells 1 according to the invention, heat transfer regions 7 of which extend upwards and against which a first temperature-regulating medium 14 flows. Each two flexurally stiff and preferably heat-conducting shaped parts 5 of galvanic cells 1 are in contact here too.

FIGS. 11 to 13 show a galvanic cell 1 according to the invention with a plurality of second connection regions 12. Second connection regions 12 are part of shaped part 5b of sheathing 4, the lower edge whereof is upturned. The upturned lower edge also serves as a heat transfer region 7. The plurality of second connection regions 12 are constituted as laterally projecting lugs, which each comprise a through-hole. Clamping screws, which engage in the battery housing or its frame, are passed through these through-holes.

FIG. 14 shows a galvanic cell 1, sheathing 4 whereof comprises two shaped parts 5a, 5b. Shaped part 5a is constituted as a sheet metal with an upturned lower edge. The upturned lower edge serves as heat transfer region 7 and as second connection regions 12. The upturned lower edge comprises two holes into which self-tapping screws engage.

FIG. 15 shows a number of galvanic cells 1 according to the invention, which each comprise a shaped part 5a with an upturned lower edge as a second connection region 12. Second connection regions 12 are screwed to a temperature-regulating element 8.

FIG. 16 shows that the screwing of a shaped part 5a of galvanic cell 1 to a temperature-regulating element 8 takes place in a region which is spatially separated from a first connection region 6. The gas-tight design of sheathing 4 is thus also obtained.

FIGS. 17 to 20 show a galvanic cell 1 with a multi-part sheathing 4. A shaped part 5b is constituted as a composite film. Another shaped part 5a of sheathing 4 is constituted as a sheet metal. Shaped part 5a comprises an upturned lower edge, which can serve as heat transfer region 7 and/or second fixing region 12. A shaped part 5a is also characterised by a region which is constituted as shell 11. Shell 11 is produced for example by a deep-drawing process and serves to accommodate electrode stack 2. Composite film 5b is put on after electrode stack 2 has been placed into shell 11 of shaped part 5a, a two-dimensionally extending contact arising along the edge regions of the two shaped parts 5a, 5b. Sheathing 4 is closed gas-tight following the firmly bonded connection of the two shaped parts 5a, 5b. Also represented are sealing strips 16, which serve to seal and improve the adhesion of the material bond in the region of the conductors. In shell 11 of shaped part 5a, electrode stack 2 of galvanic cell 1 is protected against mechanical stresses.

FIG. 20 shows a cross-section through a galvanic cell 1 according to the invention, wherein one of shaped parts 5a of sheathing 4 is constituted as a sheet metal with a cutout 11. The enlargement shows the contact between two shaped parts 5a, 5b, a current conductor 3 and a sealing strip 16. It is also shown that electrode stack 2 comprises numerous electrodes and separators. It is also shown that the electrodes of like polarity are preferably welded by means of terminal tabs to current conductor 3.

FIGS. 21 to 23 show a galvanic cell 1 according to the invention, sheathing 4 whereof comprises two shaped parts 5a, 5b. A shaped part 5b is constituted as a composite film, another shaped part 5a being constituted as a sheet metal. The region of firmly bonded connection 6 of the shaped parts, the so-called sealing, is marked by hatching. Shaped part 5a constituted as a sheet metal is present in an undeformed state and is connected, in particular in a firmly bonded manner, along its edge regions to another shaped part 5a.

FIGS. 24 to 26 show shaped part 5a constituted as a sheet metal after a bending process. In this bending process, the region of firmly bonded connection 6 of the two shaped parts 5a, 5b is upturned compared to the undeformed state. The width of shaped part 5a is thus reduced compared to the initial state. Installation space is thus saved. First connection region 6 between shaped parts 5a, 5b is also particularly well protected after the upturning.

FIGS. 27 to 29 show a galvanic cell 1 according to the invention, wherein a shaped part 5a constituted as a sheet metal additionally comprises a shell 11 for accommodating electrode stack 2. Next is firmly bonded connection 6 of shaped parts 5a, 5b that are present. Upturning of several edge regions of shaped part 5a constituted as a sheet metal then takes place by a bending process. With the protected arrangement of electrode stack 2 in shell 11 of shaped part 5a, its width is also reduced here compared to the initial state.

FIG. 30 shows an arrangement of an electrode coil 2 in a sheathing 4. Sheathing 4 and its shaped parts 5a, 5b are curved and adapted to the radius of electrode coil 2. After insertion of electrode coil 2, shaped parts 5a, 5b are connected to one another in a first connection region.

At least one electrode of the galvanic cell, particularly preferably at least one cathode, comprises a compound with the formula LiMPO₄, wherein M is at least one transition metal cation of the first row of the periodic table. The transition metal cation is preferably selected from the group comprising Mn, Fe, Ni and Ti or a combination of these elements. The compound preferably has an olivine structure, preferably a higher-order olivine.

In a further embodiment, at least one electrode of the galvanic cell, particularly preferably at least one cathode, preferably comprises a lithium manganate, preferably LiMn₂O₄ of the spinel type, a lithium cobaltate, preferably LiCoO₂, or a lithium nickelate, preferably LiNiO₂, or a mixture of two or three of these oxides, or a lithium mixed oxide which contains manganese, cobalt and nickel.

The negative and the positive electrode of a galvanic cell are preferably separated from one another by one or more separators. Such separator materials can for example also comprise porous inorganic materials, which are constituted such that a substance transport can take place through the separator normal to the separator layer, whereas a substance transport parallel to the separator layer is hindered or even prevented.

Particularly preferred are separator materials which comprise a porous inorganic material which is interspersed with particles or comprises such particles at least at its surface, which melt when a temperature threshold is reached or exceeded and which at least locally reduce the size of or close pores of the separator layer. Such particles can preferably be made from a material selected from a group of materials which comprises polymers or mixtures of polymers, waxes or mixtures of these materials.

An embodiment of the invention is particularly preferred wherein the separator layer is constituted in such a way that its pores are filled due to a capillary effect with the mobile component which participates in the chemical reaction as an educt, so that only a relatively small part of the total quantity of the mobile component present in the galvanic cell is located outside the pores of the separator layer. In this connection, the electrolyte present in the galvanic cell or one of its chemical components or a mixture of such components is a particularly preferred educt which, according to a particularly preferred example of embodiment of the invention, wets or saturates the whole porous separator layer as far as possible, but which is not to be found or to be found only in a negligible or relatively small quantity outside the separator layer. In the production of the galvanic cell, such an arrangement can be obtained by the fact that the porous separator is saturated with the electrolyte present in the galvanic cell or with another educt of a suitably selected chemical reaction, so that this educt is subsequently present for the most part only in the separator.

If, on account of a chemical reaction, only a local increase in pressure possibly occurs initially due to the formation of a gas bubble or due to local heating, this educt cannot continue to flow out of other regions into the reaction region. Insofar as and as long as it can still continue to flow, the availability of this educt at other points is correspondingly reduced. The reaction finally comes to a stop or at least remains limited to a preferably small region.

According to the invention, use is preferably made of a separator which is not electron-conducting or only poorly so, and which comprises an at least partially substance-permeable carrier. The carrier is preferably coated on at least one side with an inorganic material. As an at least partially substance-permeable carrier, use is preferably made of an organic material which is preferably constituted as a non-woven fabric. The organic material, which preferably comprises a polymer and particularly preferably a polyethylene terephthalate (PET), is coated with an inorganic, preferably ion-conducting material, which in addition is preferably ion-conducting in a temperature range from −40° C. to 200° C. The inorganic material preferably comprises at least one compound from the group of oxides, phosphates, sulphates, titanates, silicates, aluminosilicates with at least one of the elements Zr, Al, Li, particularly preferably zirconium oxide. The inorganic, ion-conducting material preferably comprises particles with a maximum diameter of less than 100 nm.

Such a separator is marketed, for example, under the brand name “Separion” by Evonik AG in Germany.

1. A galvanic cell (1) with, in particular, a prismatic or cylindrical shape comprising at least:
a first electrode stack (2), at least one current conductor (3, 3a) which is connected to the electrode stack (2), and a sheathing (4) which at least partially surrounds the electrode stack (2), wherein at least one current conductor (3, 3a) extends partially out of the sheathing (4), characterised in that that the sheathing (4) comprises at least one first shaped part (5a) and one second shaped part (5b), wherein one shaped part has a higher thermal conductivity than the other shaped parts, and that the shaped parts (5, 5a, 5b) are also provided to at least partially surround the electrode stack (2).

2. The galvanic cell (1) according to claim 1, wherein at least two shaped parts (5, 5a, 5b) of the sheathing (4) are provided, to be connected to one another at least partially and in particular in a firmly bonded manner, wherein at least two shaped parts (5, 5a, 5b) of the sheathing (4) are provided, to be connected to one another, in particular in a firmly bonded manner, in a first connection region (6).

3. The galvanic cell (1) according to claim 2, wherein at least one shaped part (5, 5a, 5b) of the sheathing (4) comprises a heat transfer region (7), which is provided in particular for making contact with a temperature-regulating element (8) and/or with a first temperature-regulating medium (14).

4. The galvanic cell (1) according to claim 3, wherein at least one shaped part (5, 5a, 5b) of the sheathing (4) is constituted flexurally stiff and/or that at least one shaped part (5, 5a, 5b) of the sheathing (4) is constituted thin-walled.

5. The galvanic cell (1) according to claim 4 wherein at least one shaped part (5, 5a, 5b) of the sheathing (4) comprises a coating (10) at least in sections.

6. The galvanic cell (1) according to claim 5, wherein at least one shaped part (5, 5a, 5b) of the sheathing (4) comprises a cutout (11), in particular for accommodating the electrode stack (2).

7. The galvanic cell (1) according to claim 6, wherein at least one shaped part (5, 5a, 5b) of the sheathing (4) comprises a second connection region (12).

8. The galvanic cell (1) according to claim 7, wherein it comprises at least one electrode, preferably at least one cathode, which comprises a compound with the formula LiMPO4, wherein M is at least one transition metal cation of the first row of the periodic table, wherein this transition metal cation is preferably selected from the group comprising Mn, Fe, Ni and Ti or a combination of these elements, and wherein the compound has an olivine structure.

9. The galvanic cell (1) according to claim 8, wherein it comprises at least one electrode, and optionally at least one cathode, which comprises a lithium manganate, a lithium cobaltate, or a lithium nickelate, or a mixture of two or three of these oxides, or a lithium mixed oxide which contains manganese, cobalt and nickel.

10. The galvanic cell (1) according to claim 9, wherein it comprises at least one separator which is not electron-conducting or only poorly so, and which comprises an at least partially substance-permeable carrier, wherein the carrier is preferably coated on at least one side with an inorganic material,
wherein, as an at least partially substance-permeable carrier, use is made of an organic material which comprises a non-woven fabric, wherein the organic material comprises a polymer,
wherein the organic material is coated with an inorganic, ion-conducting material, which in addition is ion-conducting in a temperature range from −40° C. to 200° C., wherein the inorganic material comprises at least one compound from the group of oxides, phosphates, sulphates, titanates, silicates, aluminosilicates with at least one of the elements Zr, Al, Li, and wherein the inorganic, ion-conducting material comprises particles with a maximum diameter of less than 100 nm.

11. A battery comprising at least two of the galvanic cells (1) according to claim 10, wherein
the galvanic cells (1) are disposed substantially parallel to one another,
and that at least one temperature-regulating element (8) is assigned to the battery, wherein at least one temperature-regulating element (8) is provided for making contact with at least one shaped part (5, 5a, 5b) of the sheathing (4) of at least one of the galvanic cells (1).

12. The battery according to claim 11 wherein the at least one temperature-regulating element (8) comprises at least a first channel (13), which is preferably filled with a second temperature-regulating medium (14),
and/or that the at least one temperature-regulating element (8) is in an active connection with a heat exchanger (15).

13. A method for operating a battery according to claim 12, wherein the temperature of the temperature-regulating element (8) is selected depending on the desired operating temperature of the galvanic cells (1) of the battery.

14. The method for operating a battery according to claim 13, wherein the second temperature-regulating medium (14) flows through at least a first channel (13) of the temperature-regulating element (8).

15. The method according to claim 14, wherein a first temperature-regulating medium (14) flows against or partially flows around at least one shaped part (5, 5a, 5b), in particular a heat transfer region (7) of a shaped part (5, 5a, 5b).

16. A method for producing a galvanic cell (1) according to claim 1 wherein said method comprises the step of:
connecting at least two shaped parts (5, 5a, 5b) of the sheathing (4) to one another, in particular in a firmly bonded manner,
and transforming at least one shaped part (5, 5a, 5b) of the sheathing (4) from an initial state by bending into a deformed state, wherein at least one extension of the shaped part (5, 5a, 5b) is reduced in the deformed state compared to the initial state.
